(19) United States
(12) Patent Application Publication
(10) Pub. No.: US 2002/0004850 A1
(43) Pub. Date: Jan. 10, 2002

(54) System and method of providing a messaging engine for an enterprise javabeans enabled server to achieve container managed asynchronous functionality

(76) Inventors: Krishna Sudarshan, Cupertino, CA (US); Anurag Shekhar, Patna (IN); Moses Pachaipandian, Triplicane (IN); Ramakrishnan Jayachandran, Aminjikarani (IN); Skandarajah Maharajan, Thiruvanmiyur (IN)

Correspondence Address: Ketan S. Vakil, Sheppard, Mullin, Richter & Hampton LLP, 48th Floor, 333 S. Hope Street, Los Angeles, CA, 90071, US

(21) Appl. No.: 09/816,999

(22) Filed: Mar. 23, 2001

Related U.S. Application Data
(60) Provisional application No. 60/193,003, filed on Mar. 29, 2000.
(60) Provisional application No. 60/193,007, filed on Mar. 29, 2000.

(51) Int. Cl. G06F 9/46

(52) U.S. Cl. 709/313; 709/203

(57) ABSTRACT

An asynchronous communication system is provided that includes a client system configured to communicate with a messaging service, the messaging service configured to communicate with the client system, a messaging engine, and an EJB-enabled server configured to communicate with the messaging service. The messaging engine is configured to communicate with the client system, the EJB-enabled server, and the messaging service. The messaging engine includes a deployment tool configured to deploy enterprise beans and generate asynchronous implementations of the stubs, a messaging container configured to manage asynchronous functions, and a client library configured to communicate with the messaging container. A method of generating a stub is also provided that is capable of asynchronous communication which includes generating home and remote interfaces of an enterprise bean, generating asynchronous implementations of the home and remote interfaces, and generating a class that implements the methods to include messaging calls.

### CROSS-REFERENCE TO RELATED APPLICATIONS

This application claims priority from U.S. provisional patent applications Serial Nos. 60/193,003 and 60/193,007, both filed on Mar. 29, 2000, which are herein incorporated by reference for all purposes.

1. FIELD OF THE INVENTION

The present invention relates generally to systems and methods of providing asynchronous and synchronous communications between a client system and an Enterprise JavaBeans (“EJB”) enabled server. More particularly, the present invention relates to systems and methods of providing a messaging engine to achieve container managed asynchronous functionality between the client system and the EJB-enabled server.

### 2. BACKGROUND OF THE INVENTION

The EJB architecture, developed by Sun Microsystems, Inc., is a standard component architecture for building distributed object-oriented applications in the Java programming language. A distributed object-oriented application is an application program in which parts of the application program are located in different physical locations. The EJB architecture allows application developers to build these distributed applications by combining components that are developed by using tools from multiple vendors. This architecture defines the contracts that enable these tools to develop and deploy components that can inter-operate at runtime.

The EJB architecture utilizes an EJB specification that defines the functions and operations of the components of the EJB architecture. Components are pre-developed modules of application code that run in an application server and that can be assembled into working application systems. The EJB specification provides a framework for the development and deployment of components. These components may be plugged into the EJB-enabled server to enhance the EJB-enabled server's functionality. For example, the components provided by one vendor can be easily integrated with the components provided by other vendors using the EJB specification.

FIG. 1 is a simplified block diagram of an EJB architecture 10 having a client system 12 and a server 14 and configured to perform synchronous communication. The server has a number of components including a number of containers 16 and a number of enterprise beans 18. The server provides the system level services such as load balancing, scalability, and interaction with an application server (not shown). The server is an EJB-enabled server that is configured to host the containers.

Enterprise beans 18 are components of the EJB architecture that are developed once and then deployed on multiple EJB-enabled servers without recompilation or source code modification. Enterprise beans reside in the container 16, encapsulate application logic, and contain logic functions that operate on data stored in the EJB-enabled server 14 and a database 20.

The EJB architecture defines two types of enterprise beans 18, session beans and entity beans. A key difference between session and entity beans is the fact that an entity bean has a persistent state while a session bean models interactions but does not have a persistent state. Entity beans are associated with objects and persistent records in some sort of database (Resource Manager). In contrast, session beans do not represent database records but rather represent extensions of the client application and are responsible for managing processes or tasks. The client system 12 accesses the session bean through the session bean's remote interface. Each session bean is an EJB instance associated with a single client system and is typically non-persistent. An entity bean represents information persistently stored in the database 20 and is associated with database transactions. The persistence of entity beans is handled by the entity beans themselves or by the container 16. The entity beans that represent a business object can be shared among multiple client systems 12.

To implement a bean, two interfaces need to be defined:a home interface and a remote interface. The home interface defines the bean's life cycle methods including methods for creating new beans, removing beans and finding beans. The enterprise bean's home interface defines the methods for the client system 12 to create, remove, and locate EJB objects of the same type (i.e., they are implemented by the same enterprise bean). The client system can locate the enterprise bean's home interface through the Java Naming and Directory Interface (JNDI) API. The remote interface defines the enterprise bean's business methods callable by the client system, i.e., the methods a bean presents to the outside world to do its work. Each EJB object is accessible via the enterprise bean's remote interface.

Containers 16 reside in the server 14 and are responsible for managing the interactions between an enterprise bean 18 and its server. Each container is responsible for presenting a uniform interface between the enterprise bean and the server, creating new instances of the enterprise bean, and providing services such as concurrency, locking, persistence management, remote access, and security, to the enterprise beans. Multiple enterprise beans can be installed in and deployed from the same container. The container also creates a class that implements the home interface of the enterprise bean. The container is responsible for making the home interfaces of its deployed enterprise beans available to the client system 12 through JNDI.

In the EJB-enabled server 14, the enterprise beans 18 are deployed into the containers 16. The deployment process, illustrated in FIG. 2, begins when the container generates implementations of the home interface and the remote interface of the enterprise beans for use at runtime (step S-1). These implementations are then compiled to use remote method invocation (RMI) or any other such synchronous protocols as the protocol of communication with the EJB-enabled server (step S-2). The RMI protocol uses stubs and skeletons for communication between the client side and server side components. The skeletons 15 are generated classes that are located on the server side and stubs 13 are generated classes that are located on the client side (step S-3) (see also FIG. 3). Referring to FIG. 3, stubs 13 and skeletons 15 are responsible for making the method calls on the server appear as if they were running locally on the client system 12. The stub 13 resides on the client system and is connected to the skeleton 15 via a network. The skeleton 15 is set up on a port at the EJB-enabled server side and listens for requests from the stub 13. When an object makes a method call on any home or remote interface of a bean, the control transfers from the calling object to the called object's stub. When the client system 12 invokes the method on the stub 13, the name of the method invoked and the values passed in as parameters are communicated to the skeleton 15. For example, in FIG. 3, the method invokes a create routine. The skeleton parses the incoming stream to properly invoke the method and the result is streamed back to the stub.

The EJB specification also defines the client-view contract (or client contract) and component contract. The client-view contract is the contract between the client system 12 and a container 16 and provides a uniform development model for applications using enterprise beans 18 as components. The client view contract of the enterprise bean includes a home interface, remote interface, object identity, metadata interface, and handle. The component contract defines the contract between the enterprise bean and its container.

The EJB specification also defines various other aspects of the EJB architecture, e.g., the roles played by the various users and the runtime attributes of an enterprise bean called the Deployment Descriptor. In addition, the EJB specification supports various protocols including RMI and Internet Inter-Orb Protocol (IIOP). RMI is typically the default protocol that is supported by the EJB specification. RMI is the basis of distributed object systems and is responsible for making the distributed objects' location transparent, i.e., the object's location is unknown and unimportant to the client system 12.

Using the RMI protocol, the EJB specification defines a synchronous mode of communication between the client system 12 and the server 14. Synchronous communication means that when a request is made from one object to another, the calling object will be blocked until it obtains a response from the called object. For example, when the client system makes a request, e.g., a method call, to the server, the client system making the call is blocked for the duration of the call and until a response is received (see FIG. 1). That is, the client system will be blocked until the request is communicated to the server, the request is processed by the server, and a result is returned to the client system or an exception occurs. One drawback of synchronous communication is that the client system is unable to process further requests from the user application until and unless the server has completed the previous request. This strictly sequential processing may not be necessary or appropriate for a number of applications. For instance, if a client system is sending updates to a remote server and does not care about a reply from the server, and only expects the updates to reach the server reliably, a strictly synchronous behavior is not required and such applications are better served by an asynchronous model. In this case, the client system simply queues up updates, and as long as is guaranteed reliable delivery to the server, is free to process other requests before even hearing back from the server.

As a result of the problems associated with synchronous communication and the need for asynchronous communication in a distributed environment, EJB-enabled servers 14 have been developed which provide asynchronous capabilities. Current EJB-enabled servers achieve asynchronous capability at the application level by implementing an EJB-Java Messaging Service (JMS) bridge 19 on the EJB-enabled server 14 (see FIG. 4). One drawback of the EJB-JMS implementation is that the client system has to make JMS messaging calls that the EJB-enabled server understands and executes.

It should therefore be appreciated that there is a need for asynchronous communication protocols at the container level to create a reliable, scalable, and configurable messaging engine infrastructure where there is no loss of time or data due to non-availability of resources. Also, it should be appreciated that there is a need to extend the messaging capabilities to support asynchronous communications in a multi-tier distributed EJB environment where the programmer does not have to write any explicit messaging calls. The present invention fulfills these needs as well as others.

### SUMMARY OF THE INVENTION

The present invention is directed to a system for providing asynchronous communication that includes a client system configured to communicate with a messaging service, the messaging service configured to communicate with the client system, a messaging engine, and an EJB-enabled server configured to communicate with the messaging service.

The messaging engine is a component of the EJB-enabled server and is configured to communicate with the client system, the EJB-enabled server, and the messaging service. The messaging engine includes a deployment tool configured to deploy enterprise beans and generate asynchronous implementations of the stubs, a messaging container configured to manage asynchronous functions at runtime, and a client library configured to communicate with the messaging container at runtime. The messaging engine provides for asynchronous communication between the client system and the EJB-enabled server, where the asynchronous functionality is managed at the container level.

The present invention is also directed to a method of generating a stub that is capable of asynchronous communication which includes generating home and remote interfaces of an enterprise bean, generating asynchronous implementations of the home and remote interfaces, and generating a class that implements the methods to include messaging calls. Also, the present invention is configured to generate stubs to handle the messaging calls on behalf of the programmer (bean developer).

Advantages of the present invention include providing synchronous communications, asynchronous communications or both simultaneously between the client system and the enterprise bean interfaces of the messaging container deployed in the EJB-enabled server. In addition, the bean does not need to be rewritten in order to invoke asynchronous communication. Also, the client system does not have to make messaging calls, or explicitly do marshalling and unmarshalling as in the case of JMS enabled EJB servers, thus simplifying client applications.

Since the EJB specification defines a server-side component architecture, where all remote method invocations made against a remote EJB object (entity or session beans) are inherently synchronous in nature as a result, the client gets blocked pending the completion of the remote method invocation. This time-dependent relationship between the programs being executed at the client and server systems may have certain negative implications with respect to client side responsiveness. This is because both programs have to be available to maintain the conversation; and one program waits, while the other is executed.

Asynchronous communication, with the use of the messaging server, i.e., messaging queues, provides a solution that overcomes the associated drawbacks of synchronous communication. Using the messaging queue mechanism, two communicating programs can run independently of each other in different locations— without having a logical connection between them.

The present invention provides a messaging engine that integrates asynchronous communication with EJB— to allow for asynchronous method invocations against EJB entity and session beans. In addition, the present invention provides for asynchronous communication in such a way that messaging calls are completely transparent to the client system.

Other features and advantages of the present invention should become apparent from the following description of the preferred embodiment, taken in conjunction with the accompanying drawings, which illustrate, by way of example, the principles of the present invention.

### BRIEF DESCRIPTION OF THE DRAWINGS

FIG. 1 is a simplified block diagram of a prior art EJB architecture having a client system and an EJB-enabled server, all configured to communicate synchronously;

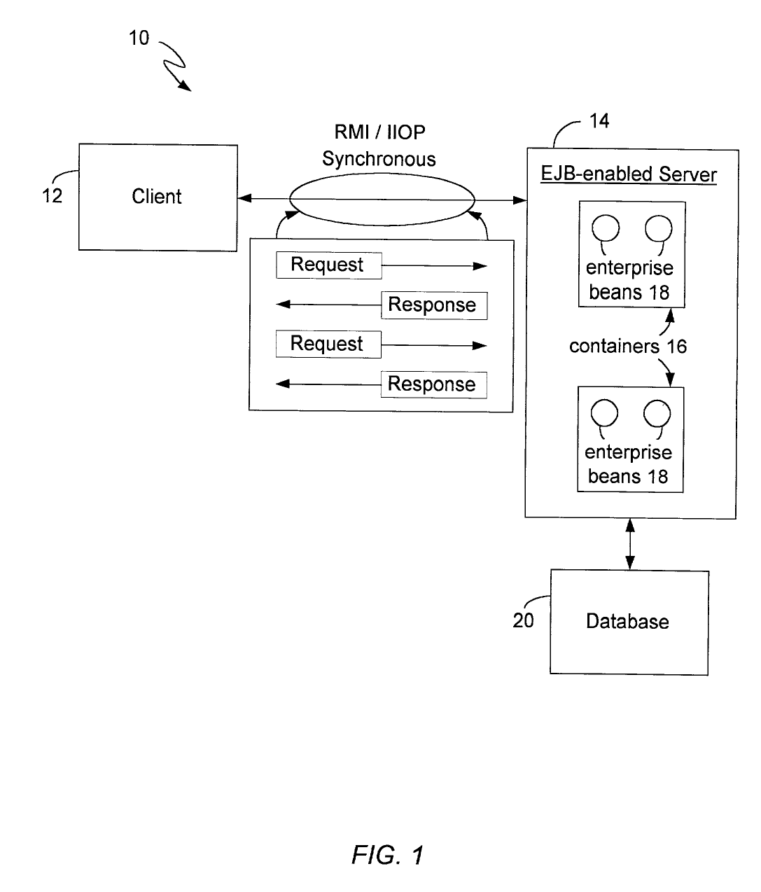

FIG. 2 is a simplified flow chart, of a prior art EJB architecture, illustrating the deployment process of enterprise beans into a container;

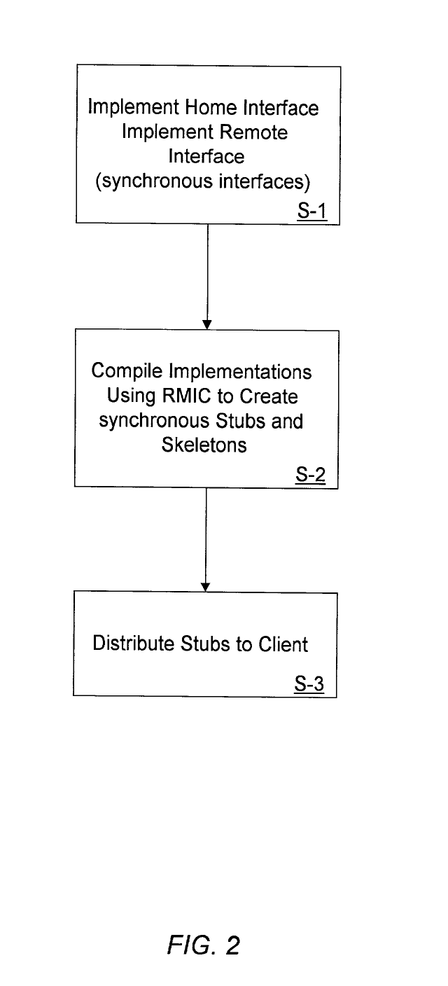

FIG. 3 is a simplified block diagram of a prior art EJB architecture having a client system and an EJB-enabled server and using stubs and skeletons to communicate synchronously;

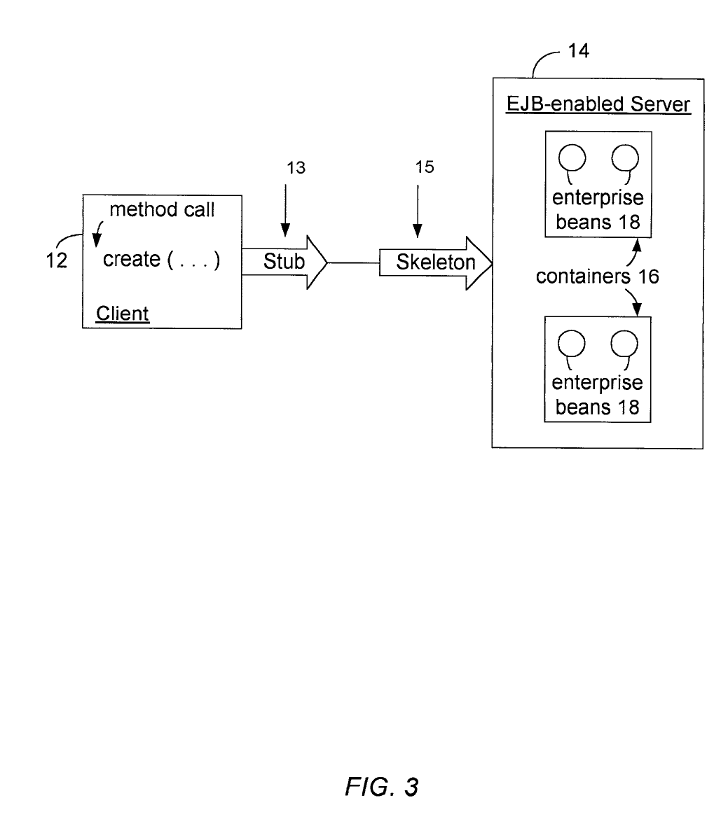

FIG. 4 is a simplified block diagram of a prior art EJB architecture having a client system and an EJB-enabled server and configured to communicate asynchronously at the application level;

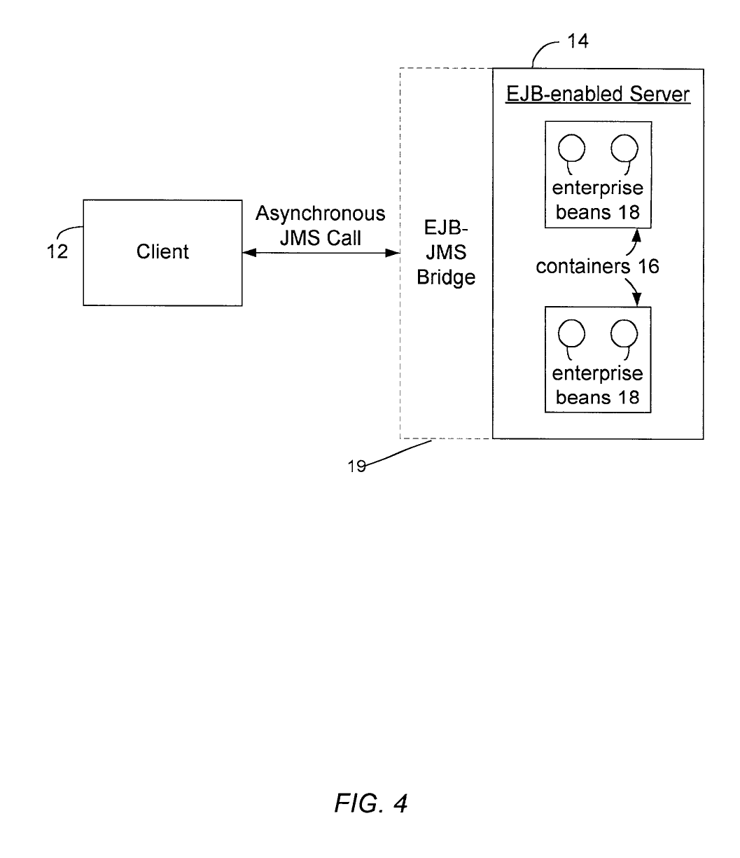

FIG. 5 is a simplified block diagram of an EJB architecture having a client system, an EJB-enabled server, and a messaging server configured to provide asynchronous messaging at the container level using a messaging engine;

FIG. 6 is a simplified flow chart illustrating the functions of the deployment tool during the deployment of enterprise beans into the EJB container to establish asynchronous messaging; and

FIG. 7 is a simplified block diagram illustrating the EJB architecture configured to facilitate asynchronous messaging between the client library, the messaging server, and the EJB-enabled server.

### DETAILED DESCRIPTION OF THE PREFERRED EMBODIMENT

In this section, the present invention is described in detail with regard to the drawing figures briefly described above.

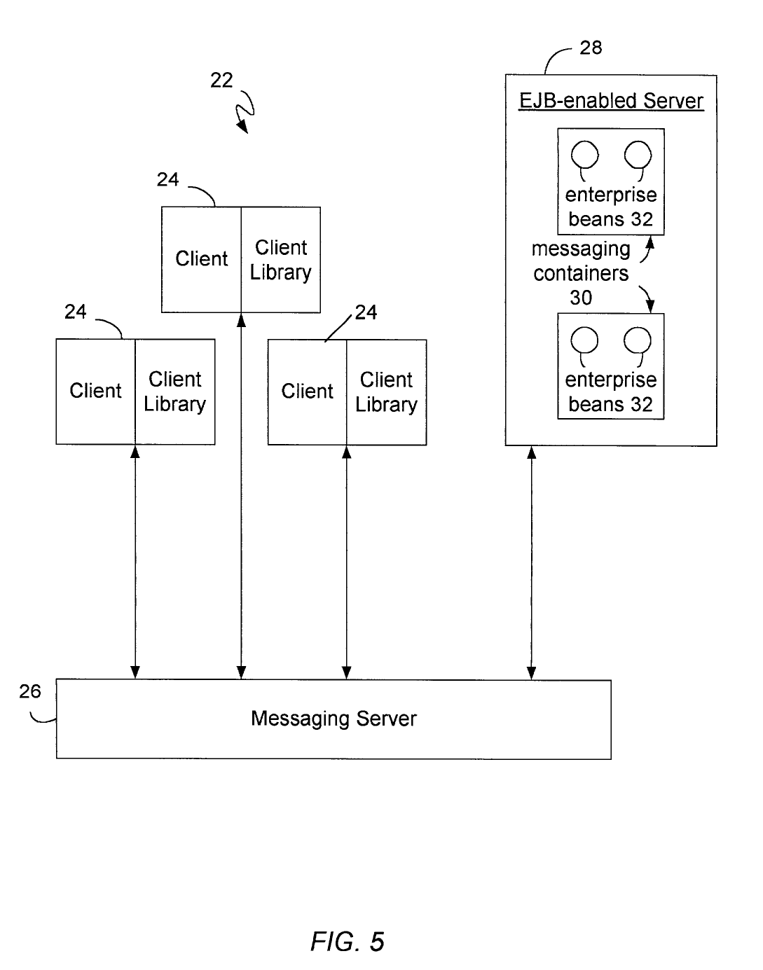

With reference to FIG. 5, there is shown an EJB architecture 22 having a client system 24, a messaging server (interchangeably referred to herein as messaging service) 26, and an EJB-enabled server 28 having a messaging engine and configured to provide asynchronous messaging at the container level using the messaging engine. The client system includes a client library that is used to route messages from the client system to the messaging server and the EJB-enabled server. The client library may also be part of the messaging engine. The EJB architecture may be implemented using one or more client systems, messaging servers, and EJB-enabled servers.

The messaging server 26 provides guaranteed message delivery. Examples of messaging servers 26 include IBM's MQ server and Oracle's AQ server. The client system 24 accesses the bean through the messaging server 26 using a method call provided by the client library.

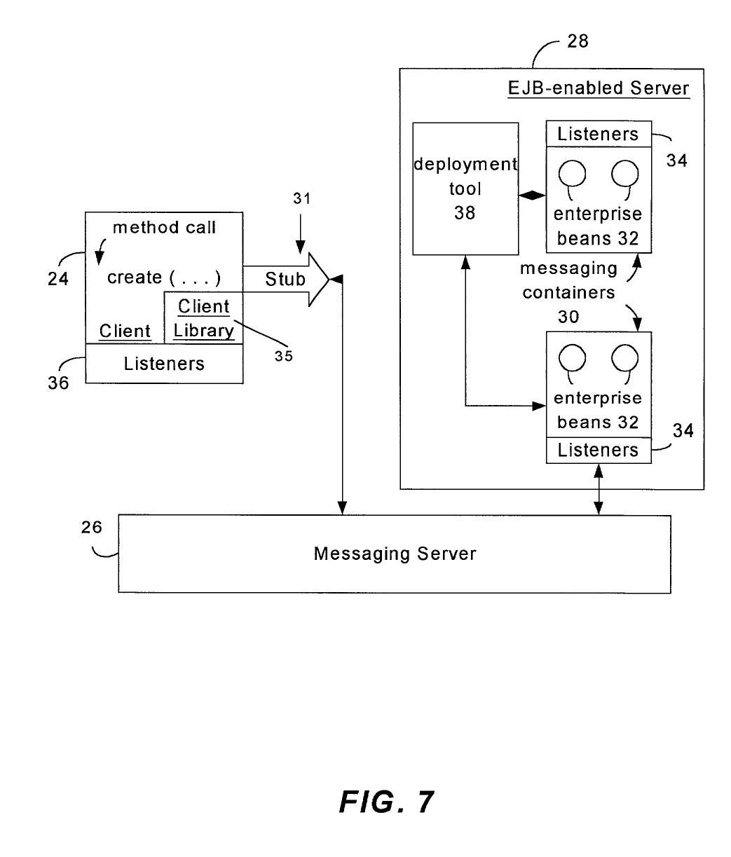

With reference to FIG. 7, to enable asynchronous communication, the client's method call is sent to a stub 31 and the stub 31 sends the call to the messaging server 26. At the EJB-enabled server, listeners 34 at the messaging container 30 are listening for these incoming calls (in the form of messages). On receipt of the messages, the messaging container 30 picks up the messages and transfers the message to the proper enterprise bean 32.

The Messaging Engine

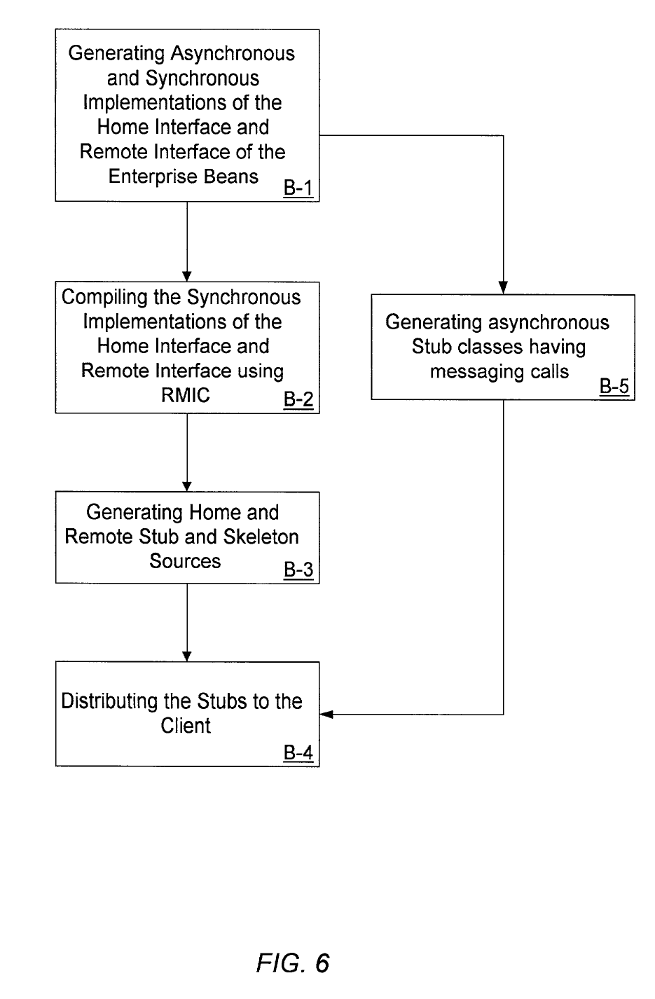

The messaging engine might include the client library 35, the messaging containers 30, and a deployment tool 38. As shown in FIG. 6 and further described below, the deployment tool of the messaging engine facilitates the generation of asynchronous stubs of the bean's home and remote interfaces and is also used to deploy the enterprise beans 32 into the messaging containers 30. The deployment tool is typically a part of the EJB-enabled server 28 and may be implemented using hardware, software, or a combination of the two.

Deployment and Configuration

FIG. 6 is a simplified flow chart that illustrates the functions of the deployment tool 38 during the deployment of the enterprise beans 32 into the messaging containers 30 to establish asynchronous messaging. The process begins with configuration process when the deployment tool prompts the deployer to input the messaging server attributes like queue name, topic name, etc. The deployment tool then generates asynchronous and synchronous implementations corresponding to the home interface and remote interface of the enterprise beans (step B-1). The methods in asynchronous home and remote interfaces are designed to have long return values. These long return values are called the call identifications (CallIDs).

The following is an example of a bean's remote interface and the generation of a corresponding asynchronous interface during deployment and configuration of the EJB:

Actual Bean's Remote Interface:

import javax.ejb.*;
import java.rmi.*;
import java.util.*;
public interface StudentEntityCMPRemoteInterface extends
javax.ejb.EJBObject {
//All Business methods of Remote Interface

public String computeGrade() throws RemoteException;
public int getId() throws RemoteException;
public void setId(int id) throws RemoteException;
public String getName() throws RemoteException;
public int getMarks() throws RemoteException;
public void setName(String name) throws RemoteException;
public void setMarks(int marks) throws RemoteException;
public void swapRecords(int recordId) throws RemoteException;
public void removeAndUpdateRecord(int recordId) throws
RemoteException;
public void removeRecord(int recordId) throws RemoteException;
public void updateRecord(int recordId) throws RemoteException;
public String getCallerName() throws RemoteException;
public boolean getRollback() throws RemoteException;
public void setRollback() throws RemoteException;
public void createRecs() throws RemoteException;

}
Corresponding generated asynchronous interface:
import java.util.*;
import java.rmi.*;
import java.security.*;
import vanda.generic.client.*;
import vanda.client.messaging.*;
import javax.ejb.*;
public interface AsyncStudentEntityCMPRemoteInterface
{
//All Business Methods ...

public long getName() throws Java.rmi.RemoteException;
public long setName(java.lang.String param0) throws

java.rmi.RemoteException;

public long removeRecord(int param0) throws
java.rmi.RemoteException;
public long computeGrade() throws java.rmi.RemoteException;
public long createRecs() throws java.rmi.RemoteException;
public long getCallerName() throws java.rmi.RemoteException;
public long getId() throws java.rmi.RemoteException;
public long getMarks() throws java.rmi.RemoteException;
public long getRollback() throws java.rmi.RemoteException;
public long isCallerInRole(java.lang.Stringparam0) throws

java.rmi.RemoteException;

public long removeAndUpdateRecord(int param0) throws

java.rmi.RemoteException;

public long setId(int param0) throws java.rmi.RemoteException;
public long setMarks(int param0) throws
java.rmi.RemoteException;
public long setRollback() throws java.rmi.RemoteException;
public long swapRecords(int param0) throws
java.rmi.RemoteException;
public long updateRecord(int param0) throws
java.rmi.RemoteException;

// Other Utility methods given as a part of the client interface

public Object getResult(long callId) throws Exception;
public boolean getStatus(long callId) throws

VandaResultAlreadyReceivedException ;

public void releaseMessagingService() ;

// all Other EJB Methods - Given an Async Look

public long getHandle() throws RemoteException;
public long remove() throws RemoteException;
public void addListener(VandaMessagingEventListener e) ;
public VandaMessagingStub getEJBHome();
public Object getPrimaryKey();
public boolean isIdentical(Object obj);

}

The above code is an example of an asynchronous interface where the first few methods are business methods defined in the remote interface of the EJB. This interface also provides for asynchronous lookup for the EJB methods like getHandle, etc. Some more methods besides the ones mentioned above may also be seen in the interface, e.g., releaseMessagingService—a utility method which could be used by the client system for performing certain operations like disconnecting from a messaging service, etc. In the above interface all the business methods are made to return a long value which is the callID, this, as explained above, could be used for result processing.

Synchronous and Asynchronous Implementations and Asynchronous Stubs

The synchronous implementations are compiled using a Remote Method Invocation Compiler (RMIC) or a similar tool (step B-2). In other words, the synchronous bean implementations use RMI (or any RMI like synchronous protocol) as the protocol of communication with the EJB-enabled server 28. In step B-3, the home and remote stub and skeleton sources are generated which are used for synchronous communications (step B-3).

For the asynchronous implementation, the bean's home and remote interfaces are used to generate asynchronous interfaces and asynchronous stubs. When the asynchronous stub is generated (step B-5), the information (such as parameters and their types, bean name, method name, object ID, etc.) needed to convert the messaging calls into messages corresponding to the EJB-enabled server 28 being used, is embedded into the asynchronous stub (see also FIG. 7). In step B-4, the stubs (both asynchronous and synchronous) are distributed to the client system. The asynchronous stubs are not dependent on the underlying messaging server 26, that is, they use a generic interface to communicate with the messaging server 26. Using the generated asynchronous stubs 31, the messages are routed to the messaging server 26. The asynchronous stubs combined with the client library provide a completely transparent method of asynchronous communication with the EJB-enabled server 28.

The following code is an example of an asynchronous stub generated for the interface described above:

import java.lang.*;
import java.util.*;
import java.sql.*;
import java.rmi.*;
import java.security.*;
import java.io.*;
import javax.ejb.*;
import vanda.generic.client.*;
import vanda.client.messaging.*;
import vanda.generic.messaging.*;
import vanda.generic.container.core.*;
import vanda.generic.server.core.*;
public class AsyncVandaStudentEntityCMPRemoteInterfaceImpl_Stub

extends VandaMessagingStub
implements AsyncStudentEntityCMPRemoteInterface , Serializable

{

public AsyncVandaStudentEntityCMPRemoteInterfaceImpl_Stub()
{

setClassName(“StudentEntityCMPRemoteInterface”);
setIsSession(false);

}
public long getName() throws java.rmi.RemoteException
{

VandaMessagingAPIInterface vandaAPI =
getVandaMessagingAPI()

;

VandaMessagingArgument vandaMesgArgs ;
long methodCallId ;
vandaMesgArgs = new VandaMessagingArgument() ;
vandaMesgArgs.setClassName(“StudentEntityCMP
RemoteInterface”)

;

vandaMesgArgs.setMethodName(“getName”) ;
if (VandaMessagingClient.isJavaClient() == false)
{
vandaMesgArgs.setSessionId(VandaMessaging
Client.getSessionId());
}
vandaMesgArgs.setCallId( methodCallId =

VandaMessagingClient.getCallId()) ;

vandaMesgArgs.setSecurityId(getSecurityId()) ;
vandaMesgArgs.setTransactionContext(get
TransactionContext()) ;
vandaMesgArgs.setRemoteObjectId(getObjectId()) ;
vandaMesgArgs.setClientId(getClientId()) ;
vandaMesgArgs.setConsumerName(getConsumerName()) ;
vandaMesgArgs.setObjectType(
VandaMessagingObjectType.EJB_OBJECT) ;
vandaMesgArgs.setTargetMessagingDescriptor(

getTargetMessagingDescriptor()) ;

registerMethodCall(vandaMesgArgs);
invokeMethod(vandaMesgArgs, “StudentEntity CMP”);
return(methodCallId) ;

}

.........
// Similarly as the above method all other methods are also implemented
}

In the above code, the stub layer does not contain any direct messaging calls, it uses a messaging object for putting messages into and getting messages from the messaging service 26. This is referred to as a plug-in implementation or plug-in module. Each method above builds a Messaging Argument object that contains details about the bean, the method to be called on that bean, parameters, their types, etc. This object would be used at the server side to call the correct method. After building this object the request object is registered with the client library for event notification.

After the object is built, the stub calls invokeMethod which performs one or both of the following:

1. Enqueue the message into the messaging server using the plug in module; or

2. Call the method directly if client is another bean and the target bean is also available at the same server.

In the above code the asynchronous stub inherits a class called VandaMessagingStub which contains all the services required for the generated stubs, but these services are transparent to the client system.

Messaging Listeners

In reference to FIG. 7, a server thread runs for each messaging server 26 configuration. Once the enterprise bean 32 is configured with the messaging server 26 attributes, a server side thread is started which is referred to as the messaging listener 34. Each messaging listener 34 is a listener thread which listens for messages from the messaging server 26. The messaging listeners 34 are responsible for getting the messages at the server side. This eliminates the need for skeletons, as implemented in RMI. The listeners 34 are generic listeners which are not dependent on the underlying messaging server 26. However, to receive messages from the messaging server 26, the messaging listener 34 uses a plug in module which is dependent on the underlying messaging server 26. Once the messaging listener 34 gets a message it delegates the message to the messaging container 30 so that it may execute the request and give back the response.

The following is an example of a generic interface that would be implemented to develop plug in modules which are messaging server 26 dependent. Generic listeners would use an implementation of the below interface for putting messages in and getting messages from the messaging server.

package vanda.generic.messaging;
import vanda.server.core.*;
public interface VandaMessagingAPIInterface
{

public void setMessagingDescriptor
(VandaMessagingDescriptorInterface

mesgDesc) ;

public VandaMessagingDescripiorInterface
getMessagingDescriptor() ;
public void setproxyMessagingDescriptor(

VandaProxyMessagingDescriptorInterface mesgDesc) ;

public VandaProxyMessagingDescriptorInterface

getProxyMessagingDescriptor() ;

public boolean isClientProxy() ;
public void enqueue (Object data) throws

VandaMessagingEnqueueException;

public void enqueue (Object data, String consumerName)

throws VandaMessagingEnqueueException;

public Object dequeue()

throws VandaMessagingDequeueException;

public Object dequeue (String consumerName)

throws VandaMessagingDequeueException;

public Object dequeueNoWait()

throws VandaMessagingDequeueException;

public Object dequeueNoWait(String consumerName)

throws VandaMessagingDequeueException;

public void enqueue (Object data, String consumerName,

VandaMessagingDescriptorInterface mesgDesc)
throws VandaMessagingEnqueueException;

public Object browse() throws

VandaMessagingOperationNotAllowedException;

public void setSendTimeout(int timeout) throws

VandaMessagingOperationNotAllowedException;

public void setReceiveTimeout(int timeout) throws

VandaMessagingOperationNotAllowedException;

public boolean isMessageTimeoutSupported ();
public boolean isReceiveTimeoutSupported ();
public boolean isBrowseSupported ();
public int getSendTimeout() throws

VandaMessagingOperationNotAllowedException;

public int getReceive Timeout() throws

VandaMessagingOperationNotAllowedException,

public void releaseMessagingService();

}

The code above references an object called Messaging Descriptor, which is a generic object that contains details about the messaging server 26. Details like topic name, queue name, etc. could be stored into this object. This object is kept opaque at the listener level for purposes of generality, but are interpreted at the messaging service 26 plug in. The following is the generic interface structure that would be implemented to create a Messaging Descriptor:

public interface VandaMessagingDescriptorInterface extends Serializable
{

public void setQueueName(String queueName) ;
public void setPortNumber(int port) ;
public void setQueueManagerName(String queueManagerName) ;
public void setChannelName(String Channel) ;
public void setUserID(String uid) ;
public void setPassword(String pwd) ;
public void setHostName(String host) ;
public void setConsumerName(String consumer) ;
public void setSubnetAddress(String subnet) ;
public void setDBURL(String dbURL) ;
public void setTopicName(String topicName) ;
public void setAPIName(String apiName) ;
public void setTopicFlag(boolean flag) ;
public void setMesgServerAddress(String address) ;
public void setProxyFlag(boolean flag) ;
public String get QueueName() throws

VandaMessagingOperationNotAllowedException;

public int getPortNumber() throws

VandaMessagingOperationNotAllowedException;

public String getQueueManagerName() throws

VandaMessagingOperationNotAllowedException;

public String getChannelName() throws

VandaMessagingOperationNotAllowedException;

public String getHostName() throws

VandaMessagingOperationNotAllowedException;

public String getUserID() throws

VandaMessagingOperationNotAllowedException;

public String getPassword() throws

VandaMessagingOperationNotAllowedException;

public String getConsumerName() throws

VandaMessagingOperationNotAllowedException;

public String getSubnetAddress() throws

VandaMessagingOperationNotAllowedException;

public String getDBURL() throws

VandaMessagingOperationNotAllowedException;

public String getAPIName() ;
public String get TopicName() throws

VandaMessagingOperationNotAllowedException;

public String getMesgServerAddress() throws

VandaMessagingOperationNotAllowedException;

public boolean isTopic() ;

}

The following code is a sample implementation of the plug in module using JMS messaging calls and publish subscribe method for communication. This abstraction layer is written for each messaging server 26 supported by the messaging engine and hides proprietary APIs from the messaging engine.

public class VandaMessagingJMSImplementation

implements VandaMessagingAPIInterface {

............

public void setMessagingDescriptor
(VandaMessagingDescriptorInterface

mesgDesc) {

mesgDescriptor = mesgDesc;

topicConnectionFactory =

new com.sun.messaging.TopicConnection
Factory(jmsAddress,

mesgDescriptor.getPortNumbe());

topicConnection =

topicConnectionFactory.createTopicConnection(mesgDescriptor.
getUserID(), mesgDescriptor.getPassword());

topicConnection.start();
topicSessionEnqueue = topicConnection.createTopicSession
(false, 1);
topicSessionDequeue = topicConnection.createTopicSession
(false, 1);

}
public VandaMessagingDescriptorInterface
getMessagingDescriptor (){

return mesgDescriptor;

}
public void enqueue (Object data) throws

VandaMessagingEnqueueException{

String topicName ;
String consumerName ;
consumerName = mesgDescriptor.getConsumerName() ;
topicName = mesgDescriptor.getTopicName() ;
topic = topicSessionEnqueue.createTopic(topicName);
topicPublisher = topicSessionEnqueue.createPublisher(topic);
objMessage = topicSessionEnqueue.createObjectMessage();
enqueueflag=true;
objMessage.setObject((Serializable)data);
objMessage.setStringProperty
(“ConsumerName”,consumerName);
topicPublisher.publish(objMessage);

}
/**
*enqueue(Object data ,String consumerName) puts the Message

Object into the messaging service with the

*details got from the messaging descriptor and the consumerName.
*/
public void enqueue (Object data, String consumerName) throws

VandaMessagingEnqueueException{

String topicName ;
topicName = mesgDescriptor.getTopicName() ;
topic = topicSessionEnqueue.createTopic(topicName);
topicPublisher = topicSessionEnqueue.createPublisher(topic);
objMessage = topicSessionEnqueue.createObjectMessage();
enqueueflag=true;
objMessage.setObject((Serializable)data);
objMessage.setStringProperty
(“ConsumerName”,consumerName);
topicPublisher.publish(objMessage);

}
public Object dequeue() throws
VandaMessagingDequeueException{

String topicName ;
String consumerName ;
topicName = mesgDescriptor.getTopicName() ;
consumerName = mesgDescriptor.getConsumerName() ;
topic = topicSessionDequeue.createTopic(topicName);
topicSubscriber =

topicSessionDequeue.createSubscriber(topic,“ConsumerName = ′′′+
consumerName +′′′′′false);

ObjectMessage objMessage =

(ObjectMessage)topicSubscriber.receive();

return objMessage.getObject();

}
public Object browse() throws

VandaMessagingOperationNotAllowedException {

throw new
VandaMessagingOperationNotAllowedException(“G003”);

}
public boolean isMessageTimeoutSupported (){

return false

}
public boolean isReceiveTimeoutSupported (){

return false;

}
public boolean isBrowseSupported (){

return false;

}
public void releaseMessagingService(){

topicPublisher.close();
topicSubscriber.close();
topicSessionEnqueue.close();
topicSessionDequeue.close();
topicConnection.close();
topicConnectionFactory = null;

| } | |
|---|---|
| ...................... | |
| TopicConnectionFactory | topicConnectionFactory; |
| TopicConnection | topicConnection; |
| TopicSession | topicSession; |
| TopicPublisher | topicPublisher; |
| TopicSubscriber | topicSubscriber; |
| Topic | topic ; |

VandaMessagingDescriptorInterface mesgDescriptor;
................

}

Client side Messaging Listeners

Apart from listeners 34 on the server side, the client system 24 also needs to run some threads for listening for response messages from the server 28, these threads are referred to as client messaging listeners 36. These are also generic listeners like the server side messaging listeners 34 since they do not depend on the underlying messaging server 26. Once a response comes from the server then the response message is taken and the client is notified using an Event Listener mechanism, further described below.

Response Notification

The client system 24 can install event listeners so that the client system 24 can be notified when responses for the request messages arrive. To do this, the client application should implement VandaMessagingEventListener class provided along with the client library 35. This event listener class has methods for result notification and exception notification.

The following is an example of the signature of the method that would be called when the result arrives:

public void methodCompleted(VandaMessagingEvent e);

The following is an example of a method signature for exception processing:

public void exceptionOccured(VandaMessagingEvent e);

The VandaMessagingEventListener interface is shown below:

public interface VandaMessagingEventListener extends EventListener
{

public void methodCompleted( VandaMessagingEvent e ) ;
public void exceptionOccured( VandaMessagingEvent e ) ;

}

To begin, the client system 24 makes a lookup method call to the JNDI for a particular enterprise bean. The call includes the name of the enterprise bean in the lookup argument of the JNDI to get a reference of the home interface. With the lookup call, the client system 24 also passes a parameter identifying whether it is the asynchronous reference of the home interface that is desired. If no parameter is passed, the default communication is synchronous communication. Otherwise, if asynchronous communication is desired, the parameter passed in this example is “vms”. If asynchronous communication is desired, the lookup would give an instantiated asynchronous stub to the client system. Once the asynchronous stub reference is retrieved, the client system 24 can make method calls, which are converted to messages and transferred to the EJB-enabled server 28 using messaging calls. Each method call corresponds to an operation requested by the client system 24. The method call includes the name of the method to be invoked and the parameters, and is transferred to the EJB-enabled server using messaging calls. The client system 24 does not make any explicit method calls directly to the EJB-enabled server.

Configuring the EJB architecture as shown in the figures and performing the above described operations, the client system 24 and the messaging containers 30 allow the enterprise bean 32 to be completely transparent to the client system 24. The present invention provides for container-managed asynchronous capabilities, as opposed to application-level asynchronous capabilities, that eliminates the need for explicit messaging calls.

The foregoing detailed description of the present invention is provided for the purposes of illustration and is not intended to be exhaustive or to limit the invention to the precise embodiment disclosed. Accordingly, the scope of the present invention is defined by the following claims.

What is claimed is:

1. An Enterprise JavaBeans architecture for providing asynchronous communication comprising:
one or more messaging servers;
a client system configured to communicate with the one or more messaging servers; and
an Enterprise JavaBeans enabled server having a messaging engine that includes a messaging container configured to manage asynchronous functions, wherein the Enterprise JavaBeans enabled server is configured to communicate with the one or more messaging servers.

2. An Enterprise JavaBeans architecture as defined in claim 1 wherein the Enterprise JavaBeans enabled server further includes a plurality of enterprise beans corresponding to the messaging container.

3. An Enterprise JavaBeans architecture as defined in claim 2 wherein the messaging engine is further configured to provide asynchronous method invocations for each of the plurality of enterprise beans.

4. An Enterprise JavaBeans architecture as defined in claim 2 wherein the messaging engine further includes a deployment tool configured to deploy the plurality of enterprise beans into the messaging container.

5. An Enterprise JavaBeans architecture as defined in claim 4 wherein the deployment tool is further configured to generate an asynchronous stub for each of the plurality of enterprise beans.

6. An Enterprise JavaBeans architecture as defined in claim 5 wherein the asynchronous stubs provide asynchronous communication at the messaging container.

7. An Enterprise JavaBeans architecture as defined in claim 5 wherein the asynchronous stubs are configured to make a plurality of messaging calls.

8. An Enterprise JavaBeans architecture as defined in claim 7 wherein the plurality of messaging calls are transparent to the client system.

9. An Enterprise JavaBeans architecture as defined in claim 1 wherein the messaging engine further includes a client library configured to communicate with the messaging container.

10. An Enterprise JavaBeans architecture as defined in claim 9 wherein the client library is configured to route messages from the client system to the one or more messaging servers and the Enterprise JavaBeans-enabled server.

11. An Enterprise JavaBeans architecture as defined in claim 1 wherein the client system does not make any explicit messaging calls.

12. An Enterprise JavaBeans architecture as defined in claim 1 wherein the client system further includes a client library configured to communicate with the messaging container.

13. A system for providing asynchronous communication comprising:
a client device,
a messaging server configured to communicate with the client device; and
an Enterprise JavaBeans enabled server having a messaging engine, a plurality of containers, and a plurality of enterprise beans that reside in each of the plurality of containers, the messaging engine configured to communicate with the client device and the messaging service and configured to provide asynchronous communication between the client device and the Enterprise JavaBeans enabled server.

14. A system as defined in claim 13 wherein the messaging engine is further configured to provide asynchronous method invocations to the plurality of enterprise beans.

15. A system as defined in claim 13 wherein the plurality of containers manage the asynchronous communication.

16. A system as defined in claim 13 wherein the messaging engine includes a deployment tool configured to deploy each of the plurality of enterprise beans into at least one of the plurality of containers.

17. A system as defined in claim 13 wherein the client device is configured to determine a home interface for each of the plurality of enterprise beans and each of the plurality of containers is configured to generate a remote interface for each of the plurality of enterprise beans.

18. A system as defined in claim 17 wherein the messaging engine includes a deployment tool configured to facilitate the generation of asynchronous implementations of the plurality of home and remote interfaces.

19. A system as defined in claim 17 wherein the plurality of home and remote interfaces are configured to generate asynchronous stubs that include messaging calls in the form of messages corresponding to the Enterprise JavaBeans enabled server.

20. A system as defined in claim 19 wherein the asynchronous stubs eliminate the need for explicit messaging calls.

21. A system as defined in claim 13 wherein the messaging engine includes a client library configured to communicate with the plurality of containers.

22. A system as defined in claim 13 wherein the messaging engine includes a client library configured to route messages to the messaging service.

23. A system as defined in claim 22 wherein the client library eliminates the need for explicit messaging calls.

24. A system as defined in claim 13 wherein the messaging service is a server.

25. A method of establishing asynchronous communication between a client system and an Enterprise JavaBeans enabled server using a messaging server, the method comprising:
storing a method call in a client library related to the client system,
transmitting the method call to a stub;
transmitting the method call from the stub to the messaging server,
listening via a messaging container located at the Enterprise JavaBeans enabled server for the method call; and
transmitting the method call to an enterprise bean corresponding to the stub.

26. A method as defined in claim 25 wherein the stub is an asynchronous stub.

27. A method as defined in claim 25 wherein the stub is a synchronous stub.

28. A method of establishing synchronous communication between a client system and a plurality of enterprise beans in a messaging container, the method comprising:
providing a home and remote interface for the plurality of enterprise beans;
generating synchronous implementations corresponding to the home and remote interface for the plurality of enterprise beans;
compiling the synchronous implementations corresponding to the home and remote interface for the plurality of enterprise beans;
generating home and remote stub and skeleton sources; and
distributing the stubs to the client system.

29. A method of establishing asynchronous messaging between a client system and a plurality of enterprise beans in a messaging container, the method comprising:
providing a home and remote interface for the plurality of enterprise beans;
generating asynchronous interfaces and asynchronous stubs corresponding to the home and remote interface for the plurality of enterprise beans; and
distributing the asynchronous stubs to the client system.

30. A method as defined in claim 29 further comprising routing messages from the client system to a messaging server using the asynchronous stubs.

31. A method as defined in claim 29 wherein generating asynchronous stubs includes embedding information to convert messaging calls into messages into the asynchronous stubs.

32. A method as defined in claim 31 wherein the information is selected from a group consisting of a parameter, a parameter type, a bean name, a method name, and an object identification.

33. A method as defined in claim 31 further comprising generating a messaging object for facilitating the routing of messages into and out of a messaging server.

34. A method as defined in claim 33 further comprising enqueing the messages into the messaging server using the messaging object.

35. A method of generating a stub that is capable of asynchronous communication, comprising:
generating method signatures from home and remote interfaces of an enterprise bean;
generating asynchronous interfaces of the home and remote interfaces; and
generating a class that implements the method signatures to include messaging calls.

36. A method of making an asynchronous call to an enterprise bean of a server, comprising:
performing a lookup operation to obtain a reference to a home interface of the enterprise bean;
adding a client-side listener to the reference to monitor response messages;
making a method call on the reference;
formatting a request message;
enqueing the request message to a client-side messaging server;
transmitting the request message from the client-side messaging server to a server-side messaging server;
enabling a server-side listener to monitor the request message;
dequeing the request message from the server-side messaging server;
extracting information from the request message at the server;
executing the method call on the enterprise bean;
formatting a result of the method call to produce the response message;
transmitting the response message to the client-side messaging server;
receiving the response message by the client-side listener; and
extracting information from the response message.
